(19) United States
(12) Patent Application Publication
(10) Pub. No.: US 2018/0268350 A1
(43) Pub. Date: Sep. 20, 2018

(54) Check Point Resolution Process

(71) Applicants: Territh Lea DiGulio, Pasadena, TX (US); Joel Mark DiGulio, Pasadena, TX (US)

(72) Inventors: Territh Lea DiGulio, Pasadena, TX (US); Joel Mark DiGulio, Pasadena, TX (US)

(21) Appl. No.: 15/461,471

(22) Filed: Mar. 16, 2017

(51) Int. Cl. G06Q 10/08; G06Q 20/18; G07F 17/12; A47G 29/14; A47G 29/16; A47F 9/04; B64F 1/36

(52) U.S. Cl. CPC G06Q 10/083; G06Q 20/18; G07F 17/12; A47F 2009/041; A47G 29/16; A47F 9/04; B64F 1/368; A47G 29/141

(57) ABSTRACT

This invention will allow airport customers to mail their non-permissible item/items from airport security checkpoints, to their desired destination, as opposed to discarding them or forfeiting their flight.

### CROSS REFERENCE TO RELATED APPLICATIONS

This nonprovisional utility application is being filed as a follow up to the provisional application filed on Mar. 16, 2016. The provisional data is below:

application Ser. No. 62/390,027

FILING DATE Mar. 16, 2016

Creation of a new process/method that will allow airline customers to retain ownership of items that currently must be discarded before proceeding through the airport security checkpoint. This is an option for airline customers that wasn't available upon filing our provisional patent application on Mar. 16, 2016 (Application No. 62/390,027).

Currently passengers have only two options when airport security notifies them that they must discard an item/items that are not allowed on passenger airplanes.
1. Dispose of the item before proceeding through the security checkpoint
2. Miss their flight and forfeit their ticket.
   The following process/method will provide an additional option and potentially multiple options in the near future (see multiple future options listed on the bottom of the page #1-3):
1. A secure container/box (kiosk style) including options for customers to select which method of mail type they desire for mailing their item/items. It will contain envelopes and address labels.
2. The customer will place the item/items in an envelope, address the envelope including a phone number, and drop it in the box.
3. The box will be checked daily. Customers will be contacted for payment. Customer item/items will be processed upon receipt of payment and the items will then be mailed to the customer's desired destination.

(An automated pay system and/or an electronic payment device or application may be added later.)

Additional variations of this process will include but will not be limited to the following processes:
1. Secure lockers to place items in for retrieval by the customer at a later date.
2. Incorporate electrical pay systems into the secure boxes and/or lockers.
3. Incorporate automation systems into the secure boxes and/or lockers.

### STATEMENT REGARDING FEDERALLY SPONSORED RESEARCH OR DEVELOPMENT

Not Applicable

### REFERENCE TO A SEQUENCE LISTING

Not Applicable

### BACKGROUND OF INVENTION

### Field of the Invention

The field of the art to which this invention pertains to is airport customers.

Often times airport customers arrive to the airport with items that are not permissible at security checkpoint locations. If a customer has an item/items that are not allowed on passenger airplanes, the item either has to be discarded or the customer has to forfeit their flight in order to keep possession of it.

The following process/method will provide an additional option and potentially multiple options in the near future (see multiple future options listed on the bottom of the page, #1-3):
1. A secure container/box (kiosk style) including options for customers to select which method of mail type they desire for mailing their item/items. It will contain envelopes and address labels.
2. The customer will place the item/items in an envelope, address the envelope including a phone number, and drop it in the box.
3. The box will be checked daily. Customers will be contacted for payment. Customer item/items will be processed upon receipt of payment and the items will then be mailed to the customer's desired destination.

(An automated pay system and/or an electronic payment device or application may be added later.)

Additional variations of this process will include but will not be limited to the following processes:
1. Secure lockers to place items in for retrieval by the customer at a later date.
2. Incorporate electrical pay systems into the secure boxes and/or lockers.
3. Incorporate automation systems into the secure boxes and/or lockers.

### BRIEF SUMMARY OF INVENTION

The Check Point Resolution Process is a service provided to airport customers. This service provides an additional option for airport customers when they have an item/items that are not allowed on passenger airplanes. This method will add the option to retain ownership of the item/items instead of being forced to discard the item/items before proceeding through the security checkpoint.

The Check Point Resolution Process will be advantageous to airport customers that have valuables that they desire to retain possession of. This type of service will ensure that every customer has an additional option.

Having a Check Point Resolution center/kiosk at every airport security checkpoint, will allow easy access for airline customers to mail non-permissible belongings to their desired destination, as opposed to discarding them or forfeiting their flight.

### BRIEF DESCRIPTION OF DRAWINGS

Not Applicable

### DETAILED DESCRIPTION OF INVENTION

Creation of a new process/method that will allow airline customers to maintain ownership of items that currently must be discarded before proceeding through the airport security checkpoint. This is an option for airline customers that wasn't available upon filing our provisional patent application (Provisional Patent Application No. 62/390,027, Filing Date: Mar. 16, 2016)

Currently passengers have only two options when airport security notifies them that they must discard an item/items that are not allowed on passenger airplanes.
1. Dispose of the item before proceeding through the security checkpoint
2. Miss their flight and forfeit their ticket.

The following process/method will provide an additional option and potentially multiple options in the near future (see multiple future options listed on the bottom of the page #1-3):
1. A secure container/box (kiosk style) including options for customers to select which method of mail type they desire for mailing their item/items. It will contain envelopes and address labels.
2. The customer will place the item/items in an envelope, address the envelope including a phone number, and drop it in the box.
3. The box will be checked daily. Customers will be contacted for payment. Customer item/items will be processed upon receipt of payment and the items will then be mailed to the customer's desired destination.

(An automated pay system and/or an electronic payment device or application may be added later.)

Additional variations of this process will include but will not be limited to the following processes:
1. Secure lockers to place items in for retrieval by the customer at a later date.
2. Incorporate electrical pay systems into the secure boxes and/or lockers.
3. Incorporate automation systems into the secure boxes and/or lockers.

1. The Check Point Resolution Process provides airport customers an additional option when an item/items are not permissible through airport security checkpoints.
This option enables customers to step out of line and mail their belongings to their desired destination, as opposed to discarding them or forfeiting their flight.
Check Point Resolution Process centers will be located at each airport security checkpoint.
This idea and/or type of business/service was not available, to our knowledge and research, upon filing our provisional patent (Application No. 62/390,027, File Date: Mar. 16, 2016).
Our invention claim is as follows: the process of retaining ownership of items that would otherwise be discarded at airport security checkpoints before being allowed to proceed through security.
